(19) United States
(12) Patent Application Publication
(10) Pub. No.: US 2002/0178236 A1
(43) Pub. Date: Nov. 28, 2002

(54) Internet broadcast system

(76) Inventors: Harikrushna S. Patel, Garland, TX (US); Sanjay H. Patel, Garland, TX (US)

Correspondence Address: Harikrushna S. Patel, Internet Broadcast Corporation, 10909 Sanden Drive, Dallas, TX, 75238, US

(21) Appl. No.: 10/056,663

(22) Filed: Jan. 24, 2002

Related U.S. Application Data
(60) Provisional application No. 60/292,940, filed on May 24, 2001.
(60) Provisional application No. 60/292,946, filed on May 24, 2001.

(51) Int. Cl. G06F 15/16

(52) U.S. Cl. 709/218; 709/250

(57) ABSTRACT

The present invention is directed to a method and apparatus for providing higher bandwidth access to the internet. A terrestrial forward path is established between an end-user and a Wireless Hub. A wireless terrestrial reverse path is then established between the Wireless Hub and the end-user. The end-user accesses the Wireless Hub using a proxy address of a master server located in the Wireless Hub. The master server controls a slave server which retrieves internet content and provides it back to the master server. The internet content is compressed into an MPEG compliant transport stream, modulated on an intermediate frequency and then up-converted. The signal is composed by using the Mac address and the TCP/IP address of several end-user systems to delimit the internet content requested by the end-user. The signal is then broadcast back to all the end-users simultaneously. The end-users receive the broadcasted signal and then down-convert, demodulate and decompress the signal. The information content requested by the end-user is then accessed, using the Mac address and the TCP/IP address.

### CROSS-REFERENCE TO RELATED APPLICATIONS

This application claims priority from U.S. Provisional Application Serial No. 60/292,940 filed May 24, 2001 which is hereby incorporated by reference in its entirety and from U.S. Provisional Application Serial No. 60/292,946 filed May 24, 2001 which is hereby incorporated by reference in its entirety.

### BACKGROUND OF THE INVENTION

1. Field of Invention

This invention relates to communications systems. Specifically, the present invention relates to terrestrial wireless communications systems.

2. Description of the Related Art

The World Wide Web or the internet has grown significantly over the last several years. Demand for internet access has consistently grown and will continue to grow over the next several years. As a result, there is a need for high bandwidth access to the internet.

A number of technologies have developed for terrestrial (e.g. land-based) access to the internet. Initially using a dial-up modem over twisted pair wiring was the preferred method of access, because this method of access took advantage of the existing telephone infrastructure. As the size of internet files became larger, higher bandwidth internet access was required. As a solution, manufacturers started to build modems that were capable of higher speeds of operation. This would allow service providers to use the same infrastructure and achieve higher bandwidth, by upgrading the modem technology.

In addition, a number of replacement technologies became available. For example, terrestrial technologies such as Digital Subscriber Line (DSL), Asymmetrical Digital Subscriber Line (ADSL), Integrated Services Digital Networks (ISDN) and Cable Modems. However, these technologies often require expensive equipment by both the service provider and the end-user. In addition, since these technologies require a significant investment in service provider infrastructure, they are not always deployed in rural or remote areas.

The communications link between an Internet Service Providers (ISP) and the end-user (e.g. often called the last mile) uses these terrestrial technologies. However, these last mile technologies are often limited in bandwidth compared to the bandwidth of the communications infrastructure in the internet. As a result, the last mile technologies often serve as a bottleneck.

A number of Satellite and terrestrial wireless technologies have emerged to address some of the problems associated with terrestrial technologies. However, many of the wireless and satellite technologies require a significant investment in infrastructure and employ portions of the radio transmitting spectrum that require licensing. The systems are often complex and require a large amount of capital investment. Laslty, the standardization, licensing and bandwidth constraints of these technologies, increase cost for end-users and service providers.

In addition to the hardware constraints associated with internet access technologies, the software and protocols required to operate and use the internet is continually changing. Protocols continually have to change to address the changing bandwidth requirements of the internet, while still operating with the legacy environment. For example, protocols compliant with the Open System Interconnection (OSI) model, such as the Transmission Control Protocol/Internet Protocol (TCP/IP), are widely deployed. As a result, new systems that are employed to address the bandwidth issues, will also have to be backward and forward compatible with the legacy and evolving TCP/IP protocol.

The protocols and the addressing schemes associated with these protocols present yet another hurdle that need to be overcome when attempting to upgrade the current infrastructure. For example, each of the terrestrial technologies such as DSL, Cable Modems, satellite, ADSL or fixed wireless, also have to be able to accommodate the current protocols and addressing schemes used by legacy technologies. For example, a typical TCP/IP compliant packet contains a source address and a destination address. The source address is the address of the end-user device transmitting the TCP/IP packet and the destination address is the address of the destination device. Therefore, if an end-user wants to communicate with a server in the internet, these two addresses are used by devices in the network to forward packets to the server (e.g. the destination) and then back to the end-user. With current terrestrial technologies a new source address is often given to the end-user, each time the end-user connects to their Internet Service Provider (ISP). For example, if an end-user is using a typical dial-up access technology to access the internet through an ISP, each time the end-user dials into the ISP and makes a connection, a new source address is given to the end-user by the ISP. Therefore, devices in the network and technologies used to upgrade the network, have to be agile enough to interface with the legacy protocols including the dynamic and evolving addressing schemes associated with these protocols.

There is a need in the art for an internet system that takes advantage of the variety of current internet access technologies and the existing internet infrastructure. There is a need in the art for a system that is both backward and forward compatible with the legacy protocols and addressing schemes. There is a need for a system that addresses the last mile problem. There is a need in the art for a cost effective system for deployment in rural areas or areas that lack installed infrastructure. There is a need for a wireless system that is not constrained by standardization or licensing requirements and as a result, is less costly to deploy. Lastly, there is the need in the art for a system that provides for larger bandwidth.

### SUMMARY

The present invention is directed to a method and apparatus for accessing the internet. A forward path or link and a reverse path or link is defined. The forward path uses a terrestrial access technology. In the method and apparatus of the present invention a forward path is a path from the end-user to a Wireless Hub. A reverse path is from the Wireless Hub back to the end-user. In one embodiment of the invention the forward path is defined from an end-user site, through an ISP, across the internet to a Wireless Hub.

A backward path or reverse path is also defined. The reverse path utilizes wireless technology. In an embodiment of the present invention the reverse path consist of a terrestrial wireless communication from a Wireless Hub to an end-user.

In a methodology of the present invention an end-user system makes an internet content request from the internet. The end-user uses a terrestrial access technology to communicate with an ISP. The end-user provides the ISP with a destination address, a proxy IP address and an Institute for Electrical & Electronic Engineers (I.E.E.E) 802.3 compliant Media Access Control (Mac) address. The ISP provides the end-user with a dynamic or changing source IP address. The ISP forwards the end-user systems internet content request, through a slave proxy server to a master proxy server which is located in a Wireless Hub. The Master proxy server accesses the internet content, requested by the end-user through the slave proxy server. The slave proxy server accesses and retrieves the internet content, which it then passes back to the requesting master proxy server. The master proxy server sends the retrieved internet content out of a default gateway to other processing devices in the Wireless Hub. A communication signal including the requested internet content is then formatted in the Wireless Hub and broadcasted back to all the end-users. A specific end-user uses the dynamic source IP address and the Mac address to parse through the broadcasted signal and access the portion of the signal that contains the internet content requested by the end-user. In embodiments where the end-user is connected to a Local Area Network (LAN), the content is received and processed in a server and then forwarded across the LAN to the final end-user.

In another embodiment of the present invention a network is presented. A system generates request information using a terrestrial forward path including an internet service provider. The request information including a dynamic address. The dynamic address changes with each connection to an internet service provider. a Hub then broadcast requested information back to an end-user using a terrestrial wireless path, in response to the request information including the dynamic address.

A Wireless Hub is presented in which a first server receives first request information. A second server coupled to the first server, generates second request information in response to the first request information received by the first server. The second server receives first internet content in response to generating the second request information. A wireless transmitter is coupled to the second server and broadcast second internet content, in response to the first internet content received by the second server.

In another embodiment, a Hub comprises a first server residing in a first IP address domain and generating first information. The Hub also comprises a second server coupled to the first server. The second server residing in a second IP address domain different from the first IP address domain, the second server generating second information in response to the first information generated by the first server. A wireless transmitter is coupled to the second server and generates third information in response to the second information generated by the second server.

In another embodiment, a Wireless Hub comprises, a server receiving IP packets from an end-user through a terrestrial path. The IP packets including dynamic source address information, the dynamic source address information changing with each connection to an internet service provider. The server retrieves internet content in response to the IP packets. A transmitter coupled to the server and broadcast information back to the end-user through a terrestrial wireless path, in response to the internet content retrieved by the server.

In another embodiment a Hub comprises a router receiving a first request. A switch coupled to the router and generating second information in response to the first request received by the router. A proxy farm coupled to the switch and generating internet content information in response to the second information generated by the switch. A gateway coupled to the proxy farm and generating a transport stream in response to the internet content information generated by the proxy farm. A modulator coupled to the gateway and generating a modulated signal in response to the transport stream generated by the gateway. A transmitter coupled to the modulator and generating an up converted signal in response to the modulated signal generated by the modulator.

An end-user system is presented. The end-user system comprises a connection interface including a connection interface address which establishing a plurality of connections with a service provider. The connection interface receives a dynamic internet protocol address in response to establishing the plurality of connections with the service provider, wherein the dynamic internet protocol address changes with each of the plurality of connections to the service provider. A wireless interface coupled to the connection interface and receiving a broadcasted signal, the broadcasted signal including the connection interface address, the dynamic internet protocol address and internet content. The wireless interface processing the broadcasted signal and providing the internet content to an end-user in response to the interface address and in response to the dynamic internet protocol address.

A computer signal is presented. The computer data signal includes media access control address information and transmission control protocol/internet protocol address information, embodied in a carrier wave and representing sequences of instructions which, when executed by a processor cause the processor to decode information. The processor performs the steps of generating a modulated signal by down converting the data signal. Checking the media access control address information in response to the modulated signal information. Generating a transport stream by demodulating the modulated signal. Checking the transmission control protocol/internet protocol address information in response to the transport stream information. Generating internet content by decompressing the transport stream.

A computer program embodied on a computer readable medium for providing information to an end-user is presented. The computer program comprises, first instructions for down converting a wireless signal thereby generating a down converted signal including media access control information. Second instructions for checking the media access control information, thereby generating a first test information. Third instruction for demodulating the down converted signal in response to the first test information, thereby generating a transport stream including a transmission control protocol/internet protocol address. Fourth instruction for testing the transmission control protocol/internet protocol address thereby generating second test information. Fifth instructions for decompressing the transport stream in response to the second test information, thereby generating internet content information

### BRIEF DESCRIPTION OF THE DRAWINGS

FIG. 1A is a system architecture implementing the present invention.

FIG. 1B is a first alternate embodiment of the system architecture.

FIG. 1C is a second alternate embodiment of the system architecture.

FIG. 2 is a flow chart displaying a method of the present invention.

FIG. 3 is a block diagram of server/end-user system implementing a method of the present invention.

FIG. 4 is a graphical user interface of a client log-in screen used in a method and apparatus of the present invention.

FIG. 5 is a block diagram of a Wireless Hub implementing the present invention.

FIG. 6 is a graphical user interface of a system operator screen used in a method and apparatus of the present invention.

FIG. 7 is a diagram of a proxy architecture used in the present invention.

FIG. 8 is a forward path message flow diagram implemented using a method and apparatus of the present invention.

FIG. 9 is a reverse path message flow diagram implemented using a method and apparatus of the present invention.

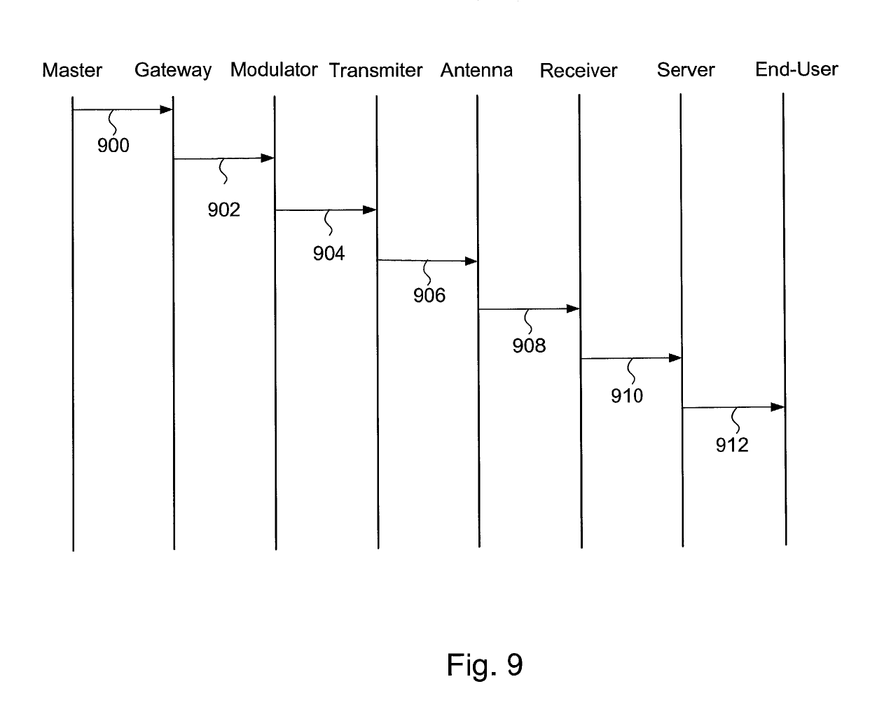

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

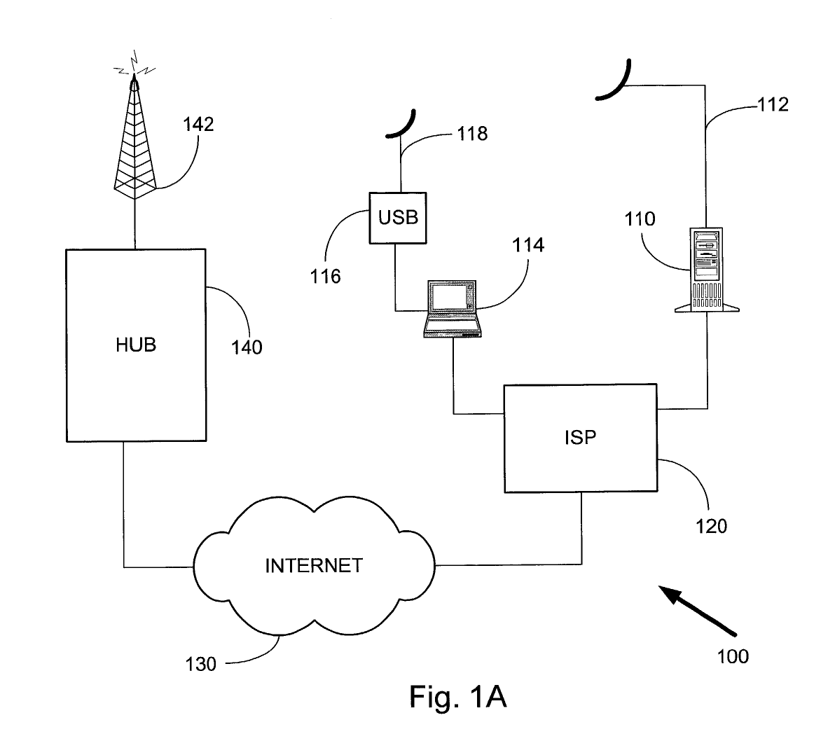

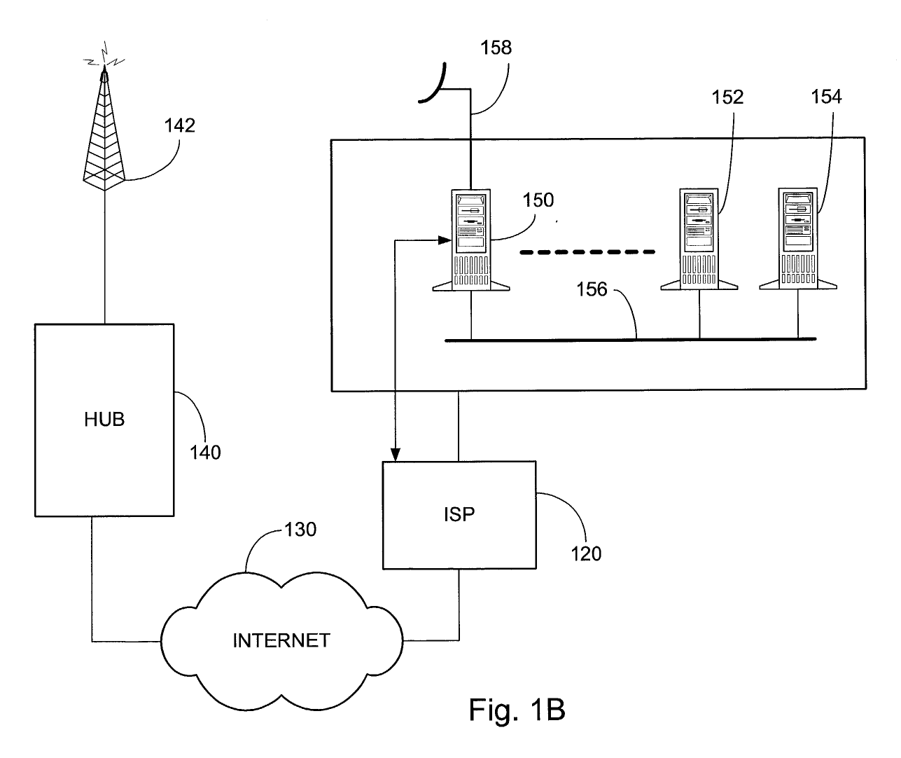

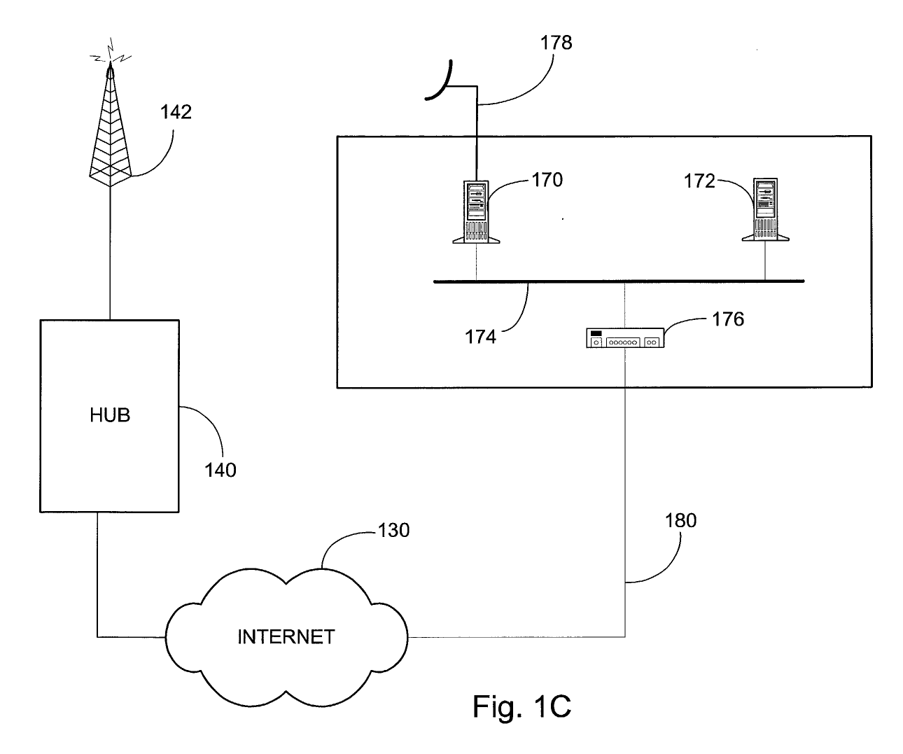

Stand-alone configurations and configurations which include interface technology are contemplated by the method and apparatus of the present invention. FIG. 1A is directed to an architecture 100 implementing the method of the present invention. In FIG. 1A a first configuration of the present invention is shown where a computer 110 includes a wireless antenna 112 for receiving wireless signals. Computer 110 may represent a stand alone computer unit which is operated by an end-user to gain access to a network. A second computer 114 is also connected to a wireless antenna 118 through an interface such as a Universal Serial Bus (USB) interface 116. Computer 114 may represent a laptop computer, a mobile computer or a mobile device which is compliant with the USB standard and is used by a second end-user to access a network. Although a USB compliant device is used in the present embodiment it should be appreciated that a number of alternative connections are available, for example, a Local Area Network (LAN) box, a PCI card or a digital video decoder may interface with computer 114. Both computers 110 and 114 use an internet service provider (ISP) 120 to access the internet 130. Computers 110 and 114 may utilize a number of terrestrial technologies to connect to the ISP such as cable modem technology, ISDN technology, DSL technology, ADSL technology or optical technology just to name a few. A Wireless Hub 140 is connected to the internet 130 and accepts request, transmitted from an end-user through computers 110 and 114. The Wireless Hub 140 is connected to a wireless antenna 142 which broadcast information to wireless receivers (e.g. dish) 112 and 118. The information is then decoded in computers 110 and 114.

In the method and apparatus of the present invention, internet request, error messaging and log-in sequences are performed using a forward and reverse communication path. In FIG. 1A a forward communication path is established from computers 110 and 114, through ISP 120, across internet 130 to Wireless Hub 140. Internet content such as files, web pages, audio, or video, is sent to the end-user through a reverse communication path. In FIG. 1A a reverse communication path is established from Wireless Hub 140 through antenna 142 to wireless receivers 112 and 118 and then to computers 110 and 114 respectively. However, is should be appreciated that a forward path is any path from the end-user to the Wireless Hub and the reverse path is any path from the Wireless Hub to the end-user.

A LAN based configuration is contemplated by the method and apparatus of the present invention. FIG. 1B is a second configuration of the present invention. In FIG. 1B a server 150 is connected to additional computers 152 and 154 across a LAN 156. Server 150 communicates directly with an ISP 120. Computers 154 and 156 may communicate with ISP 120 through the server 150. However, it should be appreciated that a bridge, router or gateway may be connected to the LAN 156 to allow direct connection between computers 152, 154 and the ISP 120. The ISP 120 is also connected to the internet 130. In addition, Wireless Hub 140 is connected between the internet 130 and antenna 142. During operation, a connection may be established between server 150, computers 152 and 154 and Wireless Hub 140. After a log-on procedure is completed between an end-user (e.g. server 150, computers 152 and 154) and the Wireless Hub 140, files are communicated from the internet 130 to the Wireless Hub 140 and out to the wireless antenna 142. Receiver 158 receives the transmitted information and server 150 decodes the information for end-user access or forwards the information to computers 152 and 154 across LAN 156. In FIG. 1B a forward communication path is from server 150 or from computers 152 and 154, through server 150, to the ISP 120. The last leg of the forward communication path is then established across the internet 130 to the Wireless Hub 140. A reverse communication path is established from Wireless Hub 140, through antenna 142, to receiver 158, to server 150. The reverse path is then completed by communicating across LAN 156 to computers 153 and 154 in the case where end-users are using computers 152 and 154. However, it should be appreciated that end-users may connect to the network through server 150, therefore the reverse communication path would terminate at server 150 for those end-users.

A configuration of the present invention using a leased line and a router is shown in FIG. 1C. In FIG. 1C a server 170 is connected to a computer 172 across a LAN 174. The server 170 and the computer 172 communicate through a router 176 and a leased line connection 180, to gain access to the internet 130. The leased line connection 180 may be a T1, DS1 or some other leased line technology. Communication is established between sever 170, computer 172 and the Wireless Hub 140 by utilizing the router 176, the leased line 180 and the internet 130. During operation, internet content request are sent through router 176, across leased line 180 to the Wireless Hub 140. Internet content is then broadcast from wireless antenna 142, back to the wireless receiver 178, for processing by server 170 or computer 172. In FIG. 1C a forward communication path is established from server 170 across LAN 174, through router 176, across the internet 130 to Wireless Hub 140. When 172 is the end-user the forward communication path would begin from computer 172 across LAN 174 to server 170 and then to router 176, or alternatively across LAN 174, to router 176, then through leased line 180 across the internet 130 to the Wireless Hub 140. In the configuration presented in FIG. 1C a reverse communication path may be established from Wireless Hub 140, through antenna 142, to receiver 178, to server 170 if server 170 is the end-user system or across LAN 174 to computer 172, if computer 172 is the end-user system.

It should be appreciated that in each of the three configurations identified above (e.g. FIGS. 1A, 1B, 1C), end-users are accessing content from web servers in the internet. The internet content may be any type of data file such as text data, audio data, or video files. The internet content may include web pages or any other resource that may be accessed through the internet. In addition, the internet content is typically communicated using the TCP/IP protocol. As a result, request for internet content may result in the transfer of protocol management packets between the devices such as error packets, retransmission packets, etc. Accordingly, the internet content may include administration and management packets. Although three configurations were discussed, several alternative configurations or combinations of the architectures shown in FIGS. 1A, 1B and 1C are contemplated for use in the method and apparatus of the present invention.

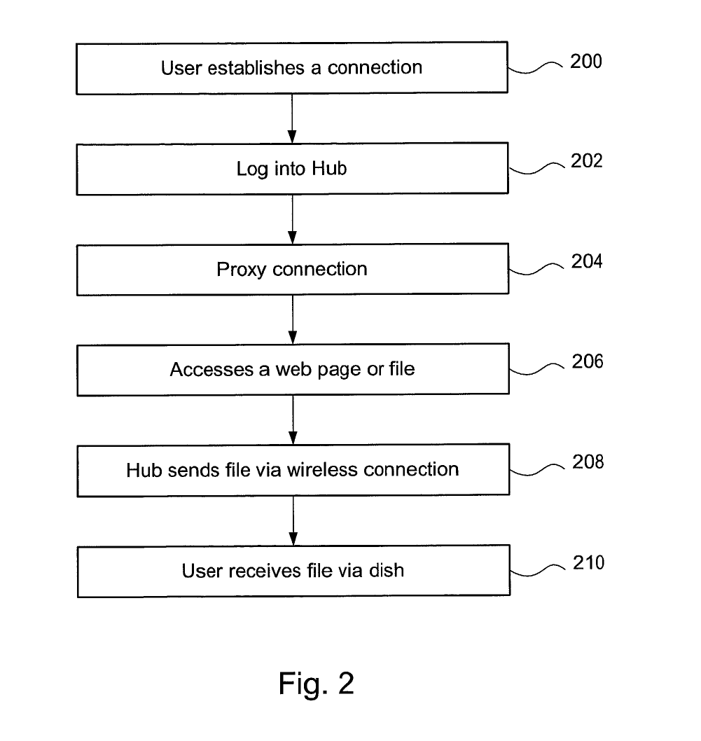

A flow chart depicting a combination of the forward communication path and the reverse communication path utilized in the present invention is shown in FIG. 2. An end-user in one of the configurations described in association with FIG. 1A, 1B or 1C, communicates using a forward communication path by establishes a connection with the Wireless Hub through the ISP (when appropriate) and across the internet as shown at 200. The connection may be established in a number of different ways. For example, a computer may communicate directly with the ISP through a dial-up connection and then communicate across the internet to the Wireless Hub. A computer may communicate across a LAN to a server which then communicates with the ISP or the computer may communicate across the LAN to the ISP directly. In another configuration, a computer may communicate across a LAN to a router or communicate through a server which then communicates with a router to gain access to the internet through a leased line. In each of the disclosed configurations a terrestrial technology such as DSL, ISDN, ADSL or cable modem is used to establish the connection between the end-user and the ISP. TCP/IP compliant packets are then used to communicate across the internet to the Wireless Hub.

A standard TCP/IP packet typically includes both a source internet protocol (IP) address and destination internet protocol (IP) address. When the end-user/sever system makes a connection with the ISP using one of the terrestrial technologies, an internet address is assigned to the end-user/server system. The internet address typically changes with each connection to the ISP. As a result, it may be said that the internet address is a dynamic address. The internet address is used as the source address, so packets carrying requested internet content may be returned back to the end-user/server system. The destination IP address is typically the address of a server that has the internet content.

Many systems also use proxy internet protocol (IP) addresses. A proxy address is the address of a server that the system operator in the end-user system or ISP would like to use in lieu of the destination address. The proxy address is often used to redirect packets through a gateway for administrative issues such as security or network management issues such as network routing. When a proxy IP address is used the destination address is replaced by the proxy address. The IP packets are then forwarded to a proxy server. The proxy server then reads the packets and finds the destination address. The proxy server may then forward the packets to the destination address. In the method and apparatus of the present invention a proxy server is used for IP address translation.

A proxy server IP address may be supplied by an end-user, server, ISP or a device in the network. For example in the present invention, the end-user is able to configure the proxy server IP address (e.g. proxy IP address) through a log-in program or through a network browser running on the end-user device. Once the proxy IP address is configured, packets communicated from the end-user systems, use the proxy server as the destination address.

After communication is established between a server/computer (end-user) and the internet, communication is then established with a Wireless Hub. The end-user logs into the Wireless Hub as shown by 202. As a result of the log-in procedure, a proxy connection is established between the end-user and the Wireless Hub as shown at 204 (e.g. a forward path or forward link is established). When the end-user accesses internet content such as a web page or a file residing in an internet server, the request is transmitted to the Wireless Hub which now serves as a proxy, as shown at 206. The destination address would be the address of the accessed web page or file residing in the internet server. The Wireless Hub then uses a reverse path or reverse link by broadcasting the internet content through a terrestrial wireless connection, back to the end-user system. The end-user system receives the internet content through a wireless receiver (e.g. dish or receiver apparatus) and then processes the internet content as shown at 210.

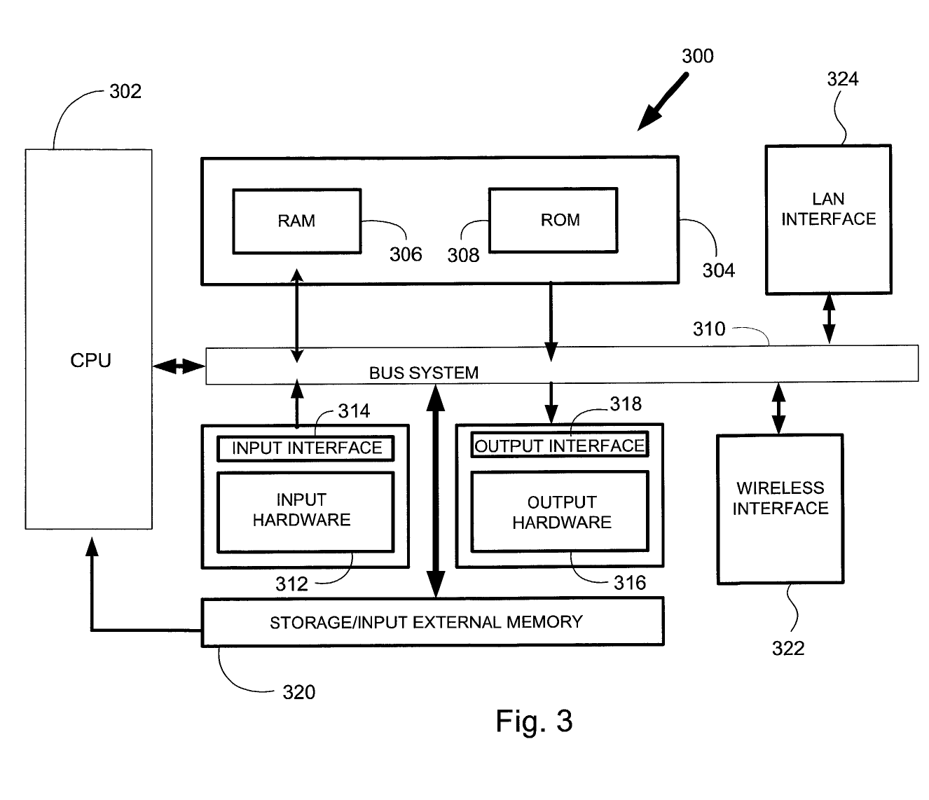

FIG. 3 is a schematic of an end-user system. The end-user system may represent a computer, a server, a video receiver or other processing device. The end-user system includes a CPU 302 which functions as the brains of the end-user system. Internal memory 304 is shown. The internal memory 304 includes a Read-Only Memory (ROM) 308 and a Random Access Memory (RAM) 306. The internal memory 304 is connected to the CPU 302 through a bus 310. The bus 310 accesses both input hardware 312 and output hardware 316 through an input interface 314 and an output interface 318, respectively. The output hardware 316 may include a modem, DSL, ADSL, ISDN or cable modem used for communication with an ISP. The bus 310 may be compliant with a standard interface such as the Peripheral Component Interface (PCI) standard. Lastly, end-user programs are stored in external memory 320 such as a hard drive. Programs such as the client log-in procedures, browser software, client file transfer procedures, initial computer configuration software, signal down conversion, demodulation, decompression and addressing procedures may be stored in the external memory 320. As portions of these procedures are required, they may be read into RAM 306. In addition, specialized hardware may be produced which would hard code any of these procedures in ROM 308.

A wireless interface is shown as 322. The wireless interface receives signals from the wireless antennas shown in FIGS. 1A, 1B and 1C. The wireless interface performs functions such as signal down-conversion, signal demodulation and signal decompression. The wireless interface 322 may perform these functions as part of a server. Alternatively, the wireless interface may perform conversion, demodulation and decompression functions in a stand-alone device.

A LAN interface 324 is also shown. The LAN interface enables the end-user system to communicate across a LAN. During operation information is communicated across the bus 310 to the LAN interface 324. The LAN interface also has connection to a LAN and can forward the communication out to the LAN, toward a final destination (e.g. end-user).

In the method and apparatus of the present invention the LAN interface may be an I.E.E.E 802.3 compliant interface. I.E.E.E. 802.3 based LAN=s communicate and identify each other with Media Access Control (MAC) addresses. As a result, LAN interface 324 has a MAC address and communicates across the LAN using the MAC address as an identifier both for transmitted information (e.g. packets) and received information. The LAN interface 324 is connected to the wireless interface 322 across bus 310. During operation the wireless interface 322 may receive a signal broadcast from a Wireless Hub. The signal contains internet content requested by an end-user. In the method of the present invention, the specific internet content required by the end-user is delimited by a MAC address. The wireless interface card uses the MAC address associated with LAN interface 324 to identify the portion of the signal directed to the end-user.

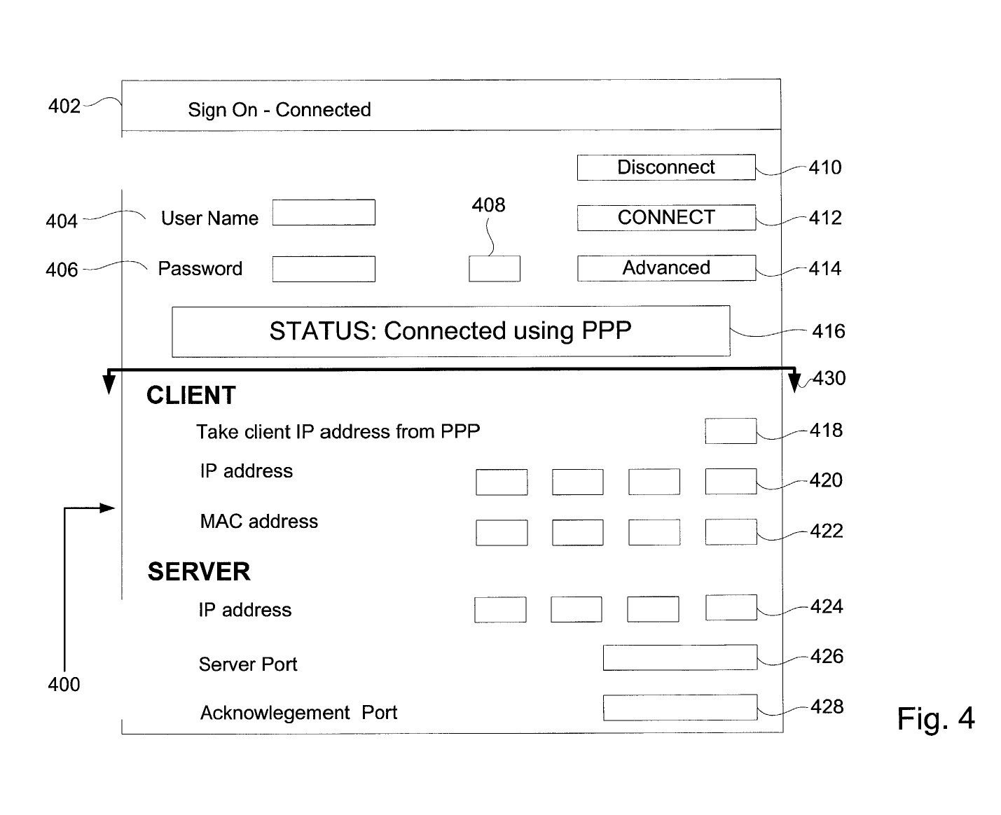

Several procedures or processes are performed using the end-user system described in FIG. 3. First a configuration and Log-in process is performed when the end-user system is initially configured. Second, a forward path addressing procedure is performed in the end-user system and third, a reverse path addressing procedure is performed in the end-user system. The configuration and log-in process, the forward path addressing scheme and the reverse path addressing scheme will be discussed with respect to FIG. 4.

The end-user system of FIG. 3 is initially configured to operate using the Graphical User Interface (GUI) displayed in FIG. 4. It should be appreciated that several different GUI=s may be utilized without departing from the spirit or the scope of the present invention. In FIG. 4 an end-user GUI 400 depicts the status of the connection as shown at 402. The status may be connected, disconnected or attempting to connect. A User Name field and a password field 404 and 406 respectively are provided. A disconnect button 410, a connect button 412 and an Advanced button 414 are shown. These buttons enable an end-user to disconnect, connect and access advanced functions. The advance function buttons cause the GUI to display its lower half, beneath line 430. A save field is shown as 408. A status field is depicted by 416. The status field 416 provides a dynamic display of the current status of the system. For example, in the current implementation status field 416 displays Aattempting to connect,@Aconnect@and Adisconnect@status.

Both client and server information are also included in the end-user configuration GUI 400. Field 418 enables an end-user to select whether they want to take the client IP address from the Point to Point Protocol (PPP). Client IP address field 420 denotes the IP address of the end-user computing system, such as the computing system discussed with respect to FIG. 3. The client IP address 420 is a dynamic IP address (e.g. changes with every connection to the ISP or internet). The client IP address is typically provided to the end-user system by the ISP, during the first hand shaking sequence performed by the end-user system and the ISP. The client Mac address field 422 denotes the Mac address of the LAN interface included in the end-user system. The LAN address would correspond to the address of the LAN interface 324 of FIG. 3. The server IP address 424 denotes the IP address of the Wireless Hub 140 shown in FIGS. 1A, 1B and 1C. The server port 426 denotes the port that the Wireless Hub will listen on, for communication and the acknowledgment port 428 denotes the port that the Wireless Hub will send acknowledgements on.

With the end-user system configured the end-user may then log into a Wireless Hub after which the end-user system may perform a forward path addressing procedure and a reverse path addressing procedure. During system Log-in the end-user system is provided with a destination IP address from the ISP. The destination IP address will be different with each connection to the ISP, as a result, in the present invention it is referred to as a dynamic source IP address. In the initial Log-in procedure, packets are sent from the end-user system to the Wireless Hub. Log-in and authentication procedures are performed after which, the end-user system is ready for communication.

Once the end-user system is ready for communication a forward path addressing process is performed whenever a end-user makes an internet request. During operation the Wireless Hub IP address functions as the proxy IP address. In addition a dynamic source IP address is provided to the end-user system with each connection to the ISP. Lastly, the Mac address which is a static address associated with a LAN interface in the end-user system is provided. Therefore, during operation, internet content request, are communicated from the end-user with the MAC address, a proxy IP address, a destination address, and a dynamic source address. The proxy IP address is the address of the Wireless Hub, the destination address is the address of the server that stores the internet content and the changing source IP address is the address that the ISP assigned to the end-user system for the current communication session. It should be noted that in one embodiment of the present invention, the connection to the ISP is made using a terrestrial (land based) path such as DSL, ISDN, cable modem, etc. The ISP forwards TCP/IP packets across the internet to the Wireless Hub using a proxy IP address (e.g. item 424 of FIG. 4) as a destination address (e.g. destination field in the TCP/IP packet). The Wireless Hub then authenticates this communication using the User Name, password, IP address and Mac address. Once the authentication is completed the forward communication path is established and end-user can use the Wireless Hub to access internet content.

A reverse path addressing process is performed by the end-user system whenever a end-user receives internet content from a Wireless Hub. Since the internet content is broadcast back to all end-users simultaneously, a specific end-users has to parse through the signal to the specific internet content requested by the end-user. A signal is broadcast from an antenna connected to the Wireless Hub back to end-user system. The signal is received by a receiver and forwarded to a wireless interface located in the end-user system (e.g. item 322 of FIG. 3). In the method of the present invention, the received signal is then down-converted, demodulated and decompressed by the wireless interface. The MAC address and the IP address are used to access the internet data.

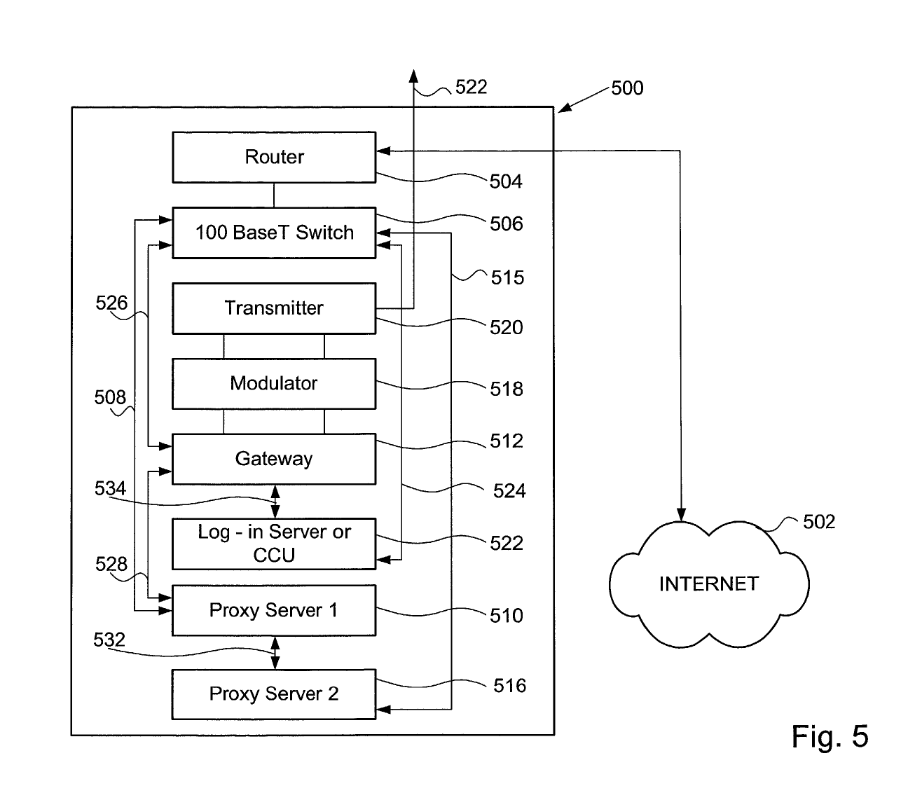

FIG. 5 displays a Wireless Hub architecture 500 of the present invention. The Wireless Hub 500 includes a router 504 for routing traffic, a switch 506 for creating a network, a transmitter 520 for up-converting signals, a modulator 518 for modulating signals, a gateway for translating signals from a first format to a second format, a log-in server 522 for managing the log-in and authentication processes and a first and second proxy server for address translation.

During the log-in process the end-user connects with the ISP and communicates Log-in information discussed with respect to FIG. 4 across the internet to the Wireless Hub 500. The router 504 receives a TCP/IP or UDP packet from the end-user. The router 504 routes these packets to the switch 506. The packets are then switched to a log-in server 522. Log-in and end-user authentication procedures are performed by the log-in server 522. Once the authentication is completed, acknowledgement packets are transmitted back to the switch 506. Ultimately, the acknowledgment packets return back across the internet 502 to the end-user. Once the end-user has received the acknowledgment packets the end-user will transmit internet content request (e.g. file request) directly to the Wireless Hub 500 for further processing. In addition, the Wireless Hub 500 is now aware of the end-user and will process the end-users request.

During general operation of the Wireless Hub 500 an end-user communicates across the Internet 502, to the Wireless Hub 500 using router 504. Router 504 accepts TCP/IP packets or UDP packets and performs Open System Interconnect (OSI) network layer forwarding of packets. A 100 BaseT switch 506 is used to switch internet traffic between the router 504 and various other components of the Wireless Hub 500. For example, the 100 BaseT switch 506 is connected to the Log-in server as shown by 524, to the gateway as shown by 526, to the first proxy server (e.g. the master proxy) as shown by 508 and to the second proxy server (e.g. slave proxy) as shown by 515. The second proxy server 516 is connected to the first proxy sever as shown by 532 and the first proxy server 510 is connected to the gateway as shown by 528.

Once an internet content request is received by the router and forwarded to the switch 506, the switch 506 forwards the internet content request to the slave proxy server 516. The internet content request leaves the end-user system with a proxy IP address of the master proxy server 510 as the destination address, therefore the slave proxy server 516 forwards the packets to the master proxy server 510. The master proxy server 510 then forwards the internet content request back to the slave proxy server 516. The slave proxy server retrieves the internet content from the internet 502, using the switch 506 and the router 504. The Master proxy server 510 is the default gateway for the slave proxy server 516. Therefore, the slave proxy server 516 retrieves the requested internet content from the internet and hands the internet content over to the master proxy server 510. The gateway 512 is the default routing path for the master proxy server 510. Therefore, the master proxy server forwards the internet content to the gateway 512.

The gateway 512 transforms the packets into a Motion Picture Experts Group (MPEG)/Digital Video Broadcast (DVB) compliant transport stream. In the present embodiment, a MPEG-2 Single channel transport stream is used. A modulator 518 then receives the transport stream and modulates the transport stream onto a carrier. In the present embodiment, the modulator includes several components including an error correction system and a nyquist filtering system. In the present invention, the error correction system further includes an energy dispersion system, a Reed-Solomon Encoding system, an Interleaving system and a Convolution encoding/puncturing system. Using the Nyquist system In phase (I) and Quadrature phase modulated signals are produced. Formatting of the signal consist of gray encoding, followed by half-Nyquist filtering. In the present embodiment, the transport stream is modulated onto a 70 Mhz Intermediate Frequency (IF) carrier using Quadrature Phase Shift Keying (QPSK) modulation. The 70 MHZ modulated signal is up-converted by the transmitter 520 for communication. In the present embodiment, the modulated signal is up-converted to a frequency between 9 Mhz and 11 MHz. The system ultimately produces a modulated signal ready for transmission. For example, using a 35.2 Mhz channel: convolution rate, the modulator will provide modulating rate of 27.50 Ms/s (Mega Symbol per second). The raw rate will be 41.25 Mbps and the useful rate of 38.01 Mbps. Ultimately the Wireless Hub will produce a 100 Mbps of useful rate using 36 Mhz per channel.

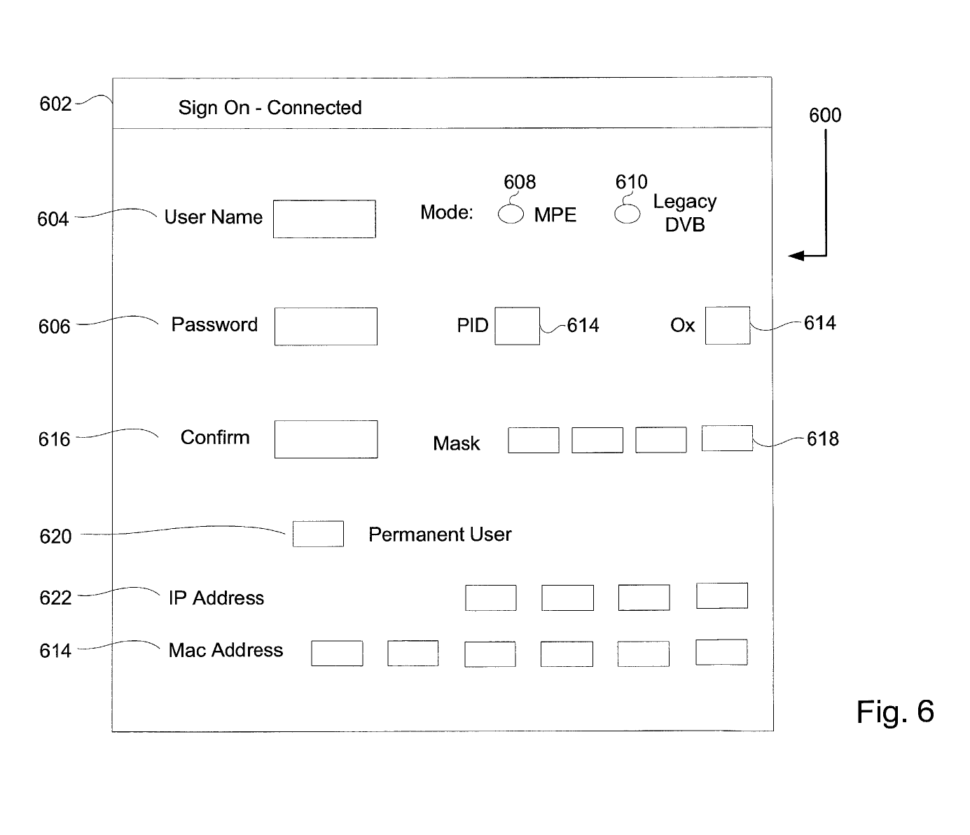

FIG. 6 displays a GUI of a Wireless Hub system operator configuration screen. In FIG. 6, the specific end-user is displayed in the end-user status bar shown as 602. An end-user name and password are shown as 604 and 606 respectively. An end-user is given the option of selecting a Multi-Protocol Encapsulation of IP data by toggling 608 or use of Legacy DVB technology as shown by 610. A Packet Identifier (PID) 612 is shown which allows the system operator (e.g. Wireless Hub operator) to place end-users into groups. Grouping end-users enables the system operator to provide quality of service or class of service. For example, a group of end-users may be given a priority or every packet from a specific end-user may be identified for communication at a specific speed. The hexadecimal version of the PID is given as 614. Confirmation of a system connection is shown as 616. The system operator may enter an IP mask as shown at 618. A permanent end-user designation is given as 620. End-user IP and MAC addresses are shown as 622 and 614 respectively.

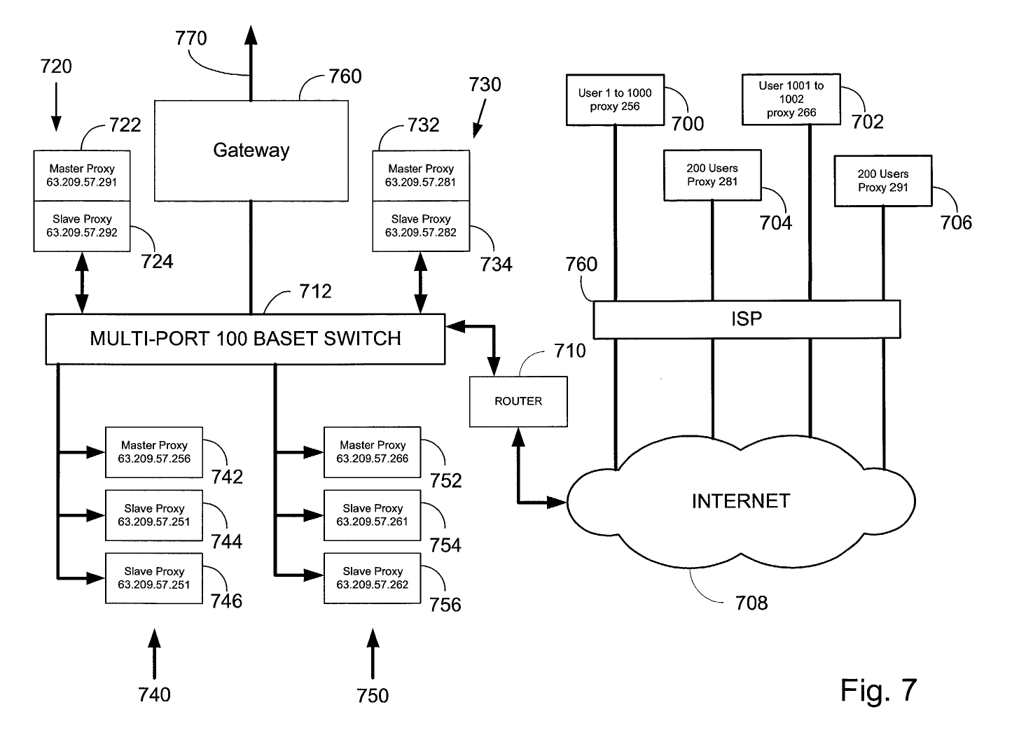

FIG. 7 displays a proxy server architecture implemented in the present invention. In FIG. 7 end-users are grouped into categories using predefined IP addresses to gain access to the internet. For example, A first group of end-users 700, may use proxy IP address 256. A second group of end-users 702, may use proxy IP address 266. Smaller clusters of end-users may also use proxy IP addresses. For example, a third group of end-users 704 may use proxy IP address 281 and a fourth group of end-users 706 may use proxy IP address 291. The proxy IP addresses represent an address domain. In the architecture of the present invention, each group of end-users accesses proxy servers by communicating across the internet 708 to the router 710 located in the Wireless Hub discussed with respect to FIG. 5. The router 710 is connected to the 100 BaseT switch 712. The 100 BaseT switch 712 is used to switch the router traffic to several proxy servers depending on the number of end-users. For example, a first proxy server farm 720, a second proxy server farm 730, a third proxy server farm 740 and a fourth proxy server farm 750 are shown. A proxy server farm consists of at least two proxy servers or two address domains in the same proxy server. In the implementation of the present invention the proxy server farms are configured in a master slave configuration. For example, the first proxy server farm 720 includes a master proxy server 722 and a slave proxy server 724. The second proxy server farm 730 includes a master proxy server 732 and a slave proxy server 734. The fourth proxy server farm 740 includes a master proxy server 742, a first slave proxy server 744 and a second slave proxy server 746. Lastly, the fourth proxy server farm 750 includes a master proxy server 752, a first slave proxy server 754 and a second slave proxy server 756. It should be appreciated that in the apparatus of the present invention a single master proxy server may be coupled to any number of slave proxy servers, depending on the number of end-users or the amount of bandwidth required.

In the apparatus of the present invention a first group of end-users 700 with proxy IP 256, would use the second proxy server farm 740. The second group of end-users 702 would use the fourth proxy server farm 750. The third group of end-users 704 would use the second proxy server farm 730 and the fourth group of end-users 706, would use the first proxy server farm 720. End-users in the first group of users 700, the second group of users 702, the third group of users 704 and the fourth group of users 706 may request internet content. The internet content request would be communicated across the internet 708 to the router 710. The router 710 would communicate with the 100 BaseT Switch 712. The 100 BaseT switch 712 would then switch the traffic to the appropriate proxy server farm. The proxy servers would retrieve the internet content requested by the end-user and the 100 Base switch would then switch the internet content to the gateway 760. The gateway then converts the internet content before the internet content is broadcast back to the end-user across a terrestrial wireless connection.

In the method of the present invention, end-users 702 will generate packets with the master proxy 732 as its proxy address. The packets will be routed through the slave proxy 734 to the master proxy 732. Once the capacity of the slave proxy 734 has been filled (e.g. there is no more room for end-users), additional slave proxy units may be added as shown with proxy server farms 740 and 750, respectively.

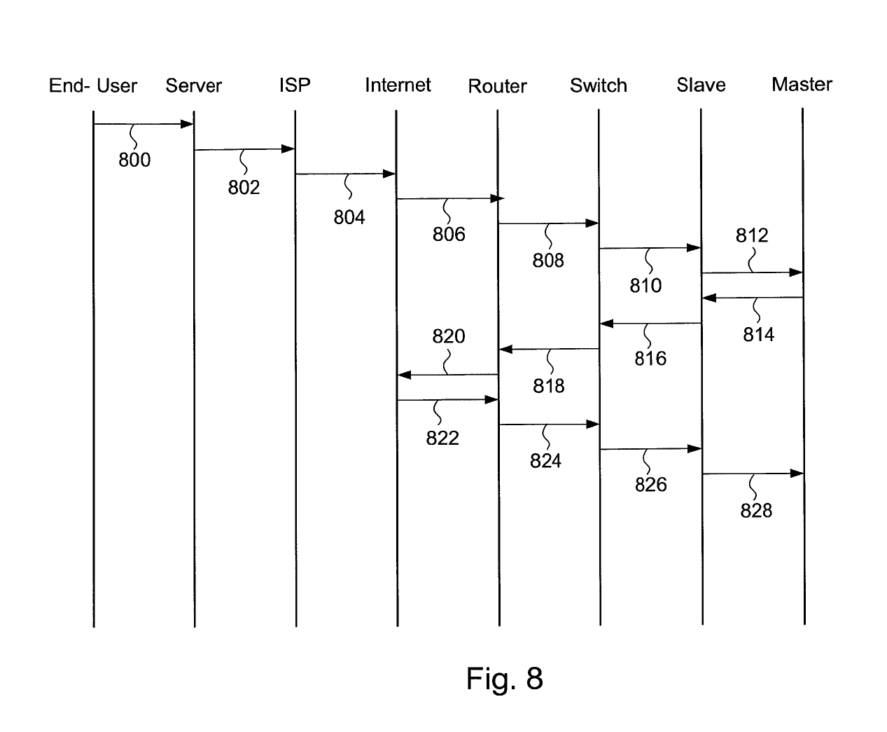

FIG. 8 is a message flow diagram of a forward path utilizing the architecture and addressing scheme associated with FIG. 7. FIG. 8 addresses a configuration where there is an end-user and a server, however, it should be appreciated that the current discussion would apply to an embodiment which includes just a server or just an end-user. In FIG. 8 a plurality of end-users communicate with a server as shown at 800. The end-users communicate with a server across a LAN by using the MAC address of the server. The server connects with the ISP using a terrestrial connection such as DSL, modem, ISDN, ADSL, cable modem, etc. For example, if a dial-up connection is used, the PPP protocol is typically used to establish the connection with the ISP as shown at 802.

The ISP provides the Server with an IP address. Therefore, whenever the server logs into the ISP a new IP address is given to the Server. This is referred to as dynamic addressing as opposed to static addressing where the server would always have the same IP address. In addition, the server has been configured with the destination address of the Master proxy. Therefore, in forming the standard TCP/IP packets used to communicate across the network, the packets associated with the server are given a dynamic source IP address and the IP address of the master proxy as a proxy address. Therefore the ISP forwards the TCP/IP packets to the internet as shown at 804. The packets are forwarded across the internet to the router which is located in the Wireless Hub, as shown at 806. The router forwards the packets to the switch as shown at 808. The switch is configured to route the TCP/IP packets to the slave proxy as shown at 810, since the slave proxy is directly connected to the internet. In the present embodiment, the slave proxy is configured with the master proxy as its default gateway therefore, the TCP/IP packets are forwarded to the master proxy as shown at 812. The master proxy reads the packets and determines that it is a request for internet content. The master proxy places its address in the source IP address field of the formulated TCP/IP packets. The request is then sent back to the slave proxy to retrieve the internet content (e.g. the destination address) as shown at 814. The packets take a path through the switch and across the router to the internet as shown by 816, 818 and 820 respectively. The requested internet content is then communicated back from the internet, through the router, across the switch, through the slave proxy back to the source of the request, the master proxy. These steps are shown by 822, 824, 826 and 828 respectively.

Since there are many users associated with the system, each with dynamic source IP addresses, the master and slave proxies are set up as proxy farms consisting of at least one master proxy and typically several slave proxies. In addition, the slave proxy is connected to the internet and is configured with the master proxy as the default gateway. Therefore, when the slave proxy sees and address that it does not know (e.g. not in its routing table), the slave proxy routes the packet to the master proxy for communication. FIG. 8 is a message flow diagram of a reverse path utilizing the architecture and addressing scheme associated with FIG. 7. In FIG. 8 the master proxy has retrieved the internet content and is ready to communicate this content back to the end-user. The master proxy is configured with the gateway as a default path, therefore the master proxy routes packets to the gateway. For example, if packets with IP addresses x.x.x.50, x.x.x.60 and x.x.x.70 represent end-user addresses, the packets will be routed to the gateway as shown by 900. The Gateway takes these packets and creates an MPEG-2 compliant transport stream, therefore in the present embodiment, the packets are combined into 188 byte packets with 16 bytes of forward error correction to make a 204 byte transport stream packet. Each transport stream packet includes a plurality of dynamic destination IP addresses, each provided for an individual end-user by the ISP and a MAC address, provided by the Ethernet interface located in each end-user system. The transport stream is sent to the modulator as shown at 902. The modulator modulates the transport stream on a 70 megahertz intermediate frequency carrier. The modulator then sends the modulated signal to the transmitter as shown at 904. The transmitter up-converts the modulated signal to between 950 megahertz and 1 gigahertz. The transmitter uses a terrestrial wireless technology to communicate the internet content from the Wireless Hub back to the end-user. Therefore, the transmitter broadcast an up-converted signal out of the antenna as shown at 906. The signal is communicated to the receiver as shown by 908.

In the present embodiment the receiver is coupled to the server or end-user system (e.g. in a standalone configuration, see FIG. 1A). The server includes a wireless interface (e.g. see FIG. 4). The wireless interface down-converts the up-converted signal. Once the signal is down-converted the end-user device checks the MAC address to determine if the information belongs to this specific end-user. Therefore each end-user receives the broadcasted information and parses through the down-converted signal to determine if the information is for that specific end-user. Once the initial MAC test is performed (e.g. there is data in the broadcasted signal for the specific end-user), the MPEG transport stream is then decompressed producing internet content. The end-user device then checks the TCP/IP address higher in the OSI protocol stack to determine if the internet content is for the end-user. This second check performs both an addressing function and a security function. Lastly, Forward error correction is performed. The end-user uses the forward error correction information to determine if the information was properly received. If the information is not properly received, the error correction information is transmitted back to the Wireless Hub using the forward path.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

What is claimed is:

1. A network comprising:
a system generating request information using a terrestrial forward path including an internet service provider, the request information including a dynamic address, the dynamic address changing with each connection to an internet service provider; and
a Hub broadcasting requested information back to an end-user using a terrestrial wireless path, in response to the request information including the dynamic address.

2. A method of routing data comprising the steps of:
generating request information using a terrestrial forward path including an internet service provider, the request information including a dynamic address, the dynamic address changing with each connection to an internet service provider; and
broadcasting requested information back to an end-user using a terrestrial wireless path, in response to the request information including the dynamic address.

3. A Wireless Hub comprising:
a first server receiving first request information;
a second server coupled to the first server and generating second request information in response to the first request information received by the first server, the second server receiving first internet content in response to generating the second request information; and
a wireless transmitter coupled to the second server and broadcasting second internet content in response to the first internet content received by the second server.

4. A Wireless Hub comprising:
a first server means for receiving first request information;
a second server means coupled to the first server means, the second server means for generating second request information in response to the first request information received by the first server means, the second server means receiving first internet content in response to generating the second request information; and
a wireless transmitter means coupled to the second server means, the wireless transmitter means for broadcasting second internet content in response to the first internet content received by the second server means.

5. A method of broadcasting internet content comprising the steps of:
receiving first request information in a first server;
generating second request information with a second server in response to the first request information received by the first server, the second server receiving first internet content in response to generating the second request information; and
broadcasting second internet content in response to the first internet content.

6. A Hub comprising:
a first server residing in a first IP address domain and generating first information;
a second server coupled to the first server, the second server residing in a second IP address domain different from the first IP address domain, the second server generating second information in response to the first information generated by the first server; and
a wireless transmitter coupled to the second server and generating third information in response to the second information generated by the second server.

7. A Hub comprising:
a first server means residing in a first IP address domain and generating first information;
a second server means coupled to the first means, the second server means residing in a second IP address domain different from the first IP address domain, the second server means generating second information in response to the first information generated by the first means; and
a third server means coupled to the second server means and generating third information in response to the second information generated by the second server means.

8. A Wireless Hub comprising:
generating first information with a first server, the first server residing in a first address domain;
generating second information with a second server in response to the first information generated by the first server, the second server residing in a second address domain different from the first address domain; and
generating third information with a wireless transmitter in response to the second information generated by the second server.

9. A Wireless Hub comprising:
A server receiving IP packets from an end-user through a terrestrial path, the IP packets including dynamic source address information, the dynamic source address information changing with each connection to an internet service provider;
the server retrieving internet content in response to the IP packets; and
a transmitter coupled to the server and broadcasting information back to the end-user through a terrestrial wireless path, in response to the internet content retrieved by the server.

10. A Wireless Hub comprising:
A server means for receiving IP packets from an end-user through a terrestrial path, the IP packets including dynamic source address information, the dynamic source address changing with each connection to an internet service provider;
the server means retrieving internet content in response to the IP packets; and
a transmitter means coupled to the server means, the transmitter means for broadcasting information back to the end-user through a terrestrial wireless path, in response to the internet content retrieved by the server means.

11. A Wireless Hub comprising:
receiving IP packets from an end-user through a terrestrial path, the IP packets including dynamic source address information, the dynamic source address changing with each connection to an internet service provider
retrieving internet content in response to the IP packets; and
broadcasting information back to the end-user through a terrestrial wireless path, in response to the internet content.

12. Hub comprising:
a router receiving a first request;
a switch coupled to the router and generating second information in response to the first request received by the router;
a proxy farm coupled to the switch and generating internet content information in response to the second information generated by the switch;
a gateway coupled to the proxy farm and generating a transport stream in response to the internet content information generated by the proxy farm;
a modulator coupled to the gateway and generating a modulated signal in response to the transport stream generated by the gateway; and
a transmitter coupled to the modulator and generating an up converted signal in response to the modulated signal generated by the modulator.

13. A Hub as set forth in claim 12, wherein the transport stream is an MPEG-2 compliant transport stream.

14. A Hub as set forth in claim 12, wherein the modulated signal is an a 70 Mhz intermediate frequency modulated signal.

15. A Hub as set forth in claim 12, wherein the up-converted signal is up-converted to between about 200 Mhz and about 70 Mhz.

16. An end-user system comprising:
a connection interface including a connection interface address and establishing a plurality of connections with a service provider,
the connection interface receiving a dynamic internet protocol address in response to establishing the plurality of connections with the service provider, wherein the dynamic internet protocol address changes with each of the plurality of connections to the service provider; and
a wireless interface coupled to the connection interface and receiving a broadcasted signal, the broadcasted signal including the connection interface address, the dynamic internet protocol address and internet content,
the wireless interface processing the broadcasted signal and providing the internet content to an end-user in response to the interface address and in response to the dynamic internet protocol address.

17. An end-user system as set forth in claim 16 wherein the connection interface is coupled to the wireless interface across an computer back plane.

18. An end-user system as set forth in claim 16 wherein the connection interface is coupled to the wireless interface across a local area network.

19. A method of communicating comprising the steps of:
establishing a plurality of connections with a service provider using a connection interface including a connection interface address,
receiving a dynamic internet protocol address with the connection interface in response to establishing the plurality of connections with the service provider, wherein the dynamic internet protocol address changes with each of the plurality of connections to the service provider; and
receiving a broadcasted signal in a wireless interface, the broadcasted signal including the connection interface address, the dynamic internet protocol address and internet content,
processing the broadcasted signal with the wireless interface address and providing the internet content to an end-user in response to the interface address and in response to the dynamic internet protocol address.

20. A computer data signal including media access control address information and transmission control protocol/internet protocol address information, embodied in a carrier wave and representing sequences of instructions which, when executed by a processor cause the processor to decode first address information and second address information, comprising the steps of:
generating a modulated signal by down converting the data signal;
checking the media access control address information in response to the modulated signal information;
generating a transport stream by demodulating the modulated signal;
checking the transmission control protocol/internet protocol address information in response to the transport stream information; and
generating internet content by decompressing the transport stream.

21. A computer program embodied on a computer readable medium for providing information to an end-user comprising:
first instructions for down converting a wireless signal thereby generating a down converted signal including media access control information;
second instructions for checking the media access control information, thereby generating a first test information;
third instruction for demodulating the down converted signal in response to the first test information, thereby generating a transport stream including a transmission control protocol/internet protocol address;
fourth instruction for testing the transmission control protocol/internet protocol address thereby generating second test information; and
fifth instructions for decompressing the transport stream in response to the second test information, thereby generating internet content information.
